(19) United States
(12) Patent Application Publication
(10) Pub. No.: US 2024/0382936 A1
(43) Pub. Date: Nov. 21, 2024

(54) Bioremediation System and Components

(71) Applicant: Aries Science and Technology, LLC, Westerville, OH (US)

(72) Inventor: Ramanathan S. LALGUDI, Westerville, OH (US)

(21) Appl. No.: 18/665,543

(22) Filed: May 15, 2024

Related U.S. Application Data
(60) Provisional application No. 63/502,415, filed on May 15, 2023.

(51) Int. Cl. B01J 20/32; B01J 20/10; B01J 20/28; B01J 20/30; B09C 1/10; C02F 3/10

(52) U.S. Cl. CPC B01J 20/3231; B01J 20/103; B01J 20/28004; B01J 20/2803; B01J 20/28054; B01J 20/3042; B01J 20/3204; B01J 20/3219; B09C 1/10; B09C 2101/00; C02F 3/104; C02F 3/107

(57) ABSTRACT

A hybrid material comprising modified porous silica and biologically active agents is disclosed. In particular, the invention discloses the design and development of amorphous silica to stabilize biologically active microorganisms and their derived enzymes, for bioremediation of hazardous substances including polar or non-polar chemicals, biological hazardous waste, radioactive hazardous waste, with potential application in the field of environmental remediation.

### RELATED APPLICATIONS

This application claims the priority benefit of U.S. Provisional Patent Application Ser. No. 63/502,415, filed 15 May 2023.

### FIELD OF THE INVENTION

The present invention relates to a hybrid, multi-functional material, a process for its preparation and system for the bio-remediation and recovery of hazardous substances.

### INTRODUCTION

One million eighty-five thousand five hundred and seven (1,085,507) barrels of hazardous liquids were spilled in the United States between 2003 and 2022¹. These hazardous chemical spills are caused by accidents involving tankers, barges, pipelines, refineries, drilling rigs, and storage facilities but also occur from recreational boats and marinas. After the hazardous materials spill, the contaminated sites are of more significant concern because of the chemicals that may be present and their propensity to persist in or move through the environment, exposing humans or the environment to hazards. Contaminated soil can leach toxic chemicals into the nearby ground or surface waters. Plants and animals can take up these materials, contaminate a human drinking water supply, or volatilize and contaminate the indoor air in overlying buildings. In dry areas, contamination in the soil can be further distributed through wind-borne dust. Once soil contamination migrates to waterways, it may also accumulate in sediments, which can be difficult to remediate and affect local ecosystems and human health. Humans can be harmed by contact with toxic and hazardous materials on a contaminated site via exposure to contaminated land, air, surface water, and groundwater. These sites must be carefully managed through containment or cleanup to prevent hazardous materials from causing harm to humans, wildlife, or ecological systems, both on and offsite.

Bioremediation is a promising technology for the cleanup of hazardous materials spills². Ongoing research and development aim to improve its effectiveness, efficiency, and applicability to various contaminated sites. Recent research and development in bioremediation of hazardous materials spills have focused on several areas, including developing new microorganisms or microbial consortia with enhanced biodegradation capabilities and using bioaugmentation and bio-stimulation to enhance bioremediation³. The development of encapsulated microbes⁴ gained considerable attention in recent years as encapsulation improves the effectiveness of microbes and their survival in harsh environmental conditions.

Natural and synthetic polymer-based coatings are the workhorse of many microencapsulated products. Encapsulation of microbes with synthetic polymers is not a potential candidate for bioremediation due to the adverse impact of the added polymer on the environment. Alginic acid, an environmentally friendly natural polymer, has shown promise in protecting microbes. However, alginate bead technology has less desirable commercial features, such as low microbial concentrations in the final product⁵. (Alginate beads typically contain 2% (w/v) spore suspension, which included 10⁶ cells/mL in 200 mL of sodium alginate solution).

Bioremediation is environmentally sound remediation technology, particularly for dealing with petroleum hydrocarbon contamination. The degradation rates of hydrocarbons are site-specific and are limited by the metabolic capabilities of the hydrocarbon-degrading microbial populations and a range of environmental factors. The effectiveness of bioremediation depends on the success of identifying and optimizing the rate-limiting factors. The controlling and optimizing bioremediation processes are complex due to many factors. These factors are the existence of a microbial population capable of degrading the pollutants, the availability of contaminants to the microbial population, and environmental factors (type of soil, temperature, pH, oxygen, or other electron acceptors and nutrients).

### 1. Bioremediation of Hydrocarbons

The oil-spill bioremediation products are presented as a magic cocktail of microorganisms. Bacillus spp. is a widely studied microbe for the bioremediation of hydrocarbons⁸. They are commercially available in large quantities and are economically attractive compared to other organisms reported in the literature for the bioremediation of hydrocarbons. Besides microbes, a combination of laccases and Mn peroxidase has been reported as effective bioremediation media for hydrocarbons⁹. Encapsulated laccases and Mn peroxidase in modified alginate microcapsules and were found to be highly efficient towards hydrocarbon degradation^{6,10}.

### 2. Importance of Silica as a Carrier in Bioremediation

Microbes are often blended with substrates and used in bioremediation. These substrates function as carriers of microbes and further protect them from external harm before they are used. Different protection strategies have been used, namely immobilization through covalent or ionic bonding or encapsulation⁴. Among the immobilization strategy, encapsulation is commercially attractive because of its low cost and ability to produce in large volumes. Among the wide choice of encapsulant materials, silica has appeared as a promising host for microbial encapsulation. The porosity of the Silica matrix can be adjusted between 10 nm and 100 microns to optimize encapsulation matrices for different microbes. As a result, silica gels have been studied extensively in the last decade to encapsulate biological actives with promising results. Microbes mixed with Silica gel have improved long-term stability^{11,12} and have been used successfully for the bioremediation of atrazine¹³. Previous studies used the sol-gel technique to produce microbes/silica gel matrix. For example, tetraethoxy orthosilicate (TEOS) is mixed with microbes, followed by the removal of ethanol to form silica gel. The reaction requires high heat (>80° C.) and an acid catalyst. These reaction conditions are detrimental to the microbes. The silica gel formed from these methods is mesoporous and has no large absorption capacity to hold the microbes and hydrocarbons. The silanol surface groups in these silica gel surfaces are weakly acidic. Therefore, they do not keep glycerin, glucose, or phosphate buffers, as they are vital nutrients for microbial survivability over a long period.

(1) Oracle BI Interactive Dashboards-SC Incident Trend. https://portal.phmsa.dot.gov
(2) Kukwa, D. T.; Afolabi, F. O.; Tetteh, E. K.; Anekwe, I. M. S.; Chetty, M.; Kukwa, D. T.; Afolabi, F. O.; Tetteh, E. K.; Anekwe, I. M. S.; Chetty, M. Bioremediation of Hazardous Wastes; IntechOpen, 2022. https://doi.org/10.5772/intechopen.102458.
(3) Rodriguez-Campos, J.; Perales-Garcia, A.; Hernandez-Carballo, J.; Martinez-Rabelo, F.; Hernández-Castellanos, B.; Barois, I.; Contreras-Ramos, S. M. Bioremediation of Soil Contaminated by Hydrocarbons with the Combination of Three Technologies: Bioaugmentation, Phytoremediation, and Vermiremediation. J. Soils Sediments 2019, 19 (4), 1981-1994. https://doi.org/10.1007/s11368-018-2213-y.
(4) Valdivia-Rivera, S.; Ayora-Talavera, T.; Lizardi-Jiménez, M. A.; García-Cruz, U.; Cuevas-Bernardino, J. C.; Pacheco, N. Encapsulation of Microorganisms for Bioremediation: Techniques and Carriers. Rev. Environ. Sci. Biotechnol. 2021, 20 (3), 815-838. https://doi.org/10.1007/s11157-021-09577-x.
(5) Pungrasmi, W.; Intarasoontron, J.; Jongvivatsakul, P.; Likitlersuang, S. Evaluation of Microencapsulation Techniques for MICP Bacterial Spores Applied in Self-Healing Concrete. Sci. Rep. 2019, 9 (1), 12484. https://doi.org/10.1038/s41598-019-49002-6.
(6) Kucharzyk, K. H.; Lalgudi, R. Enzyme Formulation and Method for Degradation. U.S. Pat. No. 10,907,143B2, Feb. 2, 2021.
(7) Wu, M.; Li, W.; Dick, W. A.; Ye, X.; Chen, K.; Kost, D.; Chen, L. Bioremediation of Hydrocarbon Degradation in a Petroleum-Contaminated Soil and Microbial Population and Activity Determination. Chemosphere 2017, 169, 124-130. https://doi.org/10.1016/j.chemosphere.2016.11.059.
(8) Baburam, C.; Mitema, A.; Tsekoa, T.; Feto, N. A. Bacillus Species and Their Invaluable Roles in Petroleum Hydrocarbon Bioremediation. In Bacilli in Agrobiotechnology: Plant Stress Tolerance, Bioremediation, and Bioprospecting; Islam, M. T., Rahman, M., Pandey, P., Eds.; Bacilli in Climate Resilient Agriculture and Bioprospecting; Springer International Publishing: Cham, 2022; pp 101-126. https://doi.org/10.1007/978-3-030-85465-2_5.
(9) Morsi, R.; Bilal, M.; Iqbal, H. M. N.; Ashraf, S. S. Laccases and Peroxidases: The Smart, Greener and Futuristic Biocatalytic Tools to Mitigate Recalcitrant Emerging Pollutants. Sci. Total Environ. 2020, 714, 136572. https://doi.org/10.1016/j.scitotenv.2020.136572.
(10) Kucharzyk, K. H.; Benotti, M.; Darlington, R.; Lalgudi, R. Enhanced Biodegradation of Sediment-Bound Heavily Weathered Crude Oil with Ligninolytic Enzymes Encapsulated in Calcium-Alginate Beads. J. Hazard. Mater. 2018, 357, 498-505. https://doi.org/10.1016/j.jhazmat.2018.06.036.
(11) Nassif, N.; Bouvet, O.; Noelle Rager, M.; Roux, C.; Coradin, T.; Livage, J. Living Bacteria in Silica Gels. Nat. Mater. 2002, 1 (1), 42-44. https://doi.org/10.1038/nmat709.
(12) Mutlu, B. R.; Hirschey, K.; Wackett, L. P.; Aksan, A. Long-Term Preservation of Silica Gel-Encapsulated Bacterial Biocatalysts by Desiccation. J. Sol-Gel Sci. Technol. 2015, 74 (3), 823-833. https://doi.org/10.1007/s10971-015-3690-8.
(13) Mutlu, B. Silica Gel Encapsulated Cell Bioremediation System for Water Treatment, 2016. http://conservancy.umn.edu/handle/11299/185586
(14) Cho, G. S.; Lee, D. -H.; Lim, H. M.; Lee, S. -H.; Kim, C.; Kim, D. S. Characterization of Surface Charge and Zeta Potential of Colloidal Silica Prepared by Various Methods. Korean J. Chem. Eng. 2014, 31 (11), 2088-2093. https://doi.org/10.1007/s11814-014-0112-5.

### SUMMARY OF THE INVENTION

In one aspect, the invention provides a method of making a bioremediation system medium, comprising: providing a porous silica support; modifying the support by reaction with a coupling agent to form a siloxy-containing moiety bound to the silica support through oxygen bonds to form a modified support comprising a surface moiety comprising an ether moiety and a carboxylate end group; and coupling the surface moiety with a biologically active agent. A preferred process comprises a) adding/applying a coupling agent to a silica support and b) adding/applying an acid and c) adding/applying a biologically active agent. The coupling agent is preferably a functional silane and, in a particularly preferred embodiment comprises 3-glycidyloxypropyl trimethoxysilane. The organic acid preferably comprises citric acid, itaconic acid, citraconic acid, lactic acid, glucaric acid and tartaric acid. The biologically active agent may comprise, for example, Bacillus spp strains and/or enzymes derived from bacteria and fungi.

In a related aspect, the invention provides a bioremediation system comprising a modified silica support coupled to biologically active agents for removing or reducing hazardous contaminants.

In a related aspect, the invention provides a method for removing or reducing the availability of hazardous contaminants.

In another aspect, the present invention concerns the use of a modified silica support coupled to biologically active agents as an absorbent substrate for polar or non-polar chemicals, biological hazardous waste and radioactive hazardous waste.

In any of the aspects, the invention can be further characterized by one or any combination of the following: the medium of claim 1 having 0.5 to 5.0% or 0.7 to 1.5% volatile matter; having a density of between 0.25 and 0.50 or between 0.30 and 0.40 g/mL; having an angle of repose between 15 and 30 or 17 to 25 degrees; having a pH of between 2.5 and 5.0 or between 3.0 and 4.0 when dispersed at 1 mass % in an aqueous solution; having a HAZMAT sorption capacity of between 200 and 300 or between 220 and 270 volume per 100 g of sample; having a particle size of between 200 and 700 or between 350 and 550 or between 400 and 500 μm; having a total porosity of between 70 and 90% or between 75 and 85%; having a total pore area of between 80 and 130 m²/g or between 90 and 120 m²/g or between 100 and 110 m²/g; wherein the biologically active agent comprises Bacillus spp, Bacillus subtilis, Bacillus licheniformis, Bacillus pumilus, Bacillus amyloliquefaciens, Bacillus megaterium, and Brevibacillus laterosporus; wherein the biologically active agent comprises enzymes derived from bacteria and fungi; wherein the surface moiety has a chain length between the siloxy moiety and the carboxylate of between 3 and 15 or between 3 and 10 or between 3 and 7 or between 4 and 8; wherein the biologically active agents decontaminate a hazardous substance into a less toxic substance; wherein the modified silica particles are made by mixing amorphous silica, an organic acid, a quaternary ammonium salt, and a functional silane and heating the mixture above 80° C. and below 180° C. preferably for at least one hour and not exceeding six hours; wherein the media is disposed in a housing; wherein the housing comprises a valve that selectively permits one or more hazardous materials to enter the housing; wherein the system comprises an indicator that indicates the progress of a decontamination process; wherein the housing comprises at least one valve that opens when it encounters hazardous substances and allows the hazardous substances to enter the housing; wherein the media absorbs at least three percent of its weight of the hazardous substances that enter a container housing the media; wherein the bioremediation system contains at least one window that changes color after decontamination and visually indicates the completion of the decontamination process; wherein the hazardous substances are polar or non-polar chemicals, biological hazardous waste, or radioactive hazardous waste; a method of remediating a spill of chemical compounds, comprising contacting the chemical compounds with the bioremediation system media of any of the above claims; wherein the coupling agent comprises a silicon atom having 2 to 3 hydroxy and/or alkoxy groups and 1 to 2 Si—C bonds; wherein the coupling agent comprises an epoxy moiety that is further reacted to form the surface moiety; wherein the coupling agent comprises at least two ether moieties and at least two carboxylate groups; wherein the biologically active agent comprises Bacillus spp, Bacillus subtilis, Bacillus licheniformis, Bacillus pumilus, Bacillus amyloliquefaciens, Bacillus megaterium, Brevibacillus laterosporus, and enzymes derived from bacteria and fungi; wherein the coupling agent contains at least one beta hydroxyl ester; wherein the beta hydroxyl ester improves shelf-life stability to the biologically active agents; wherein the modified silica particles are made by mixing amorphous silica, an organic acid, a quaternary ammonium salt, and a functional silane and heating the mixture above 80° C. and below 180° C. preferably for at least one hour and not exceeding six hours; wherein the biologically active agent is a solid that is physically mixed with the modified silica particles or a liquid absorbed onto the modified silica particles; wherein the organic acid is citric acid, itaconic acid, citraconic acid, lactic acid, glucaric acid, or tartaric acid; wherein the quaternary ammonium salt is choline chloride, tetramethyl ammonium chloride, or betaine; wherein the bioremediation system treats or can treat a spill volume of 10,000 gallons of hazardous substances; wherein the functional silane is (3-glycidyloxypropyl)trimethoxysilane; wherein the bioremediation system is or can be disposed of, incinerated, or recycled; wherein the hazardous substances are polar or non-polar chemicals, biological hazardous waste, or radioactive hazardous waste; wherein the biologically active agents decontaminate a hazardous substance into a less toxic substance; wherein the bioremediation system is or can be disposed of, incinerated, or recycled; and/or wherein the hazardous substances are polar or non-polar chemicals, biological hazardous waste, or radioactive hazardous waste.

The term “medium” is the singular of media. Typically, the medium (or media) is a powder but it could take other forms. The “biologically active agent” can be an organism such as bacteria or fungus, or can be an enzyme.

Porous silica is a well-known term and is a well-known adsorbent material; there are numerous commercially available porous silica powders.

This invention can be used as the sole process for reducing availability of hazardous substances in contaminated liquid, or can be used to complement and/or enhance the reduction in availability and/or the amount of hazardous substances that is attained by existing technologies.

Additional advantages and novel features of the present invention will be apparent from the descriptions and demonstrations set forth herein. As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of.” As is standard terminology, “systems” include to apparatus and materials (such as reactants and products) and conditions within the apparatus. All ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

The invention is further illustrated in the descriptions and examples below. In some preferred embodiments, the invention may be further characterized by any selected descriptions from the examples, for example, within ±30% or ±20% (or within ±10%) of any of the values in any of the examples, tables or figures. The scope of the present invention, in its broader aspects, is not intended to be limited by these examples.

### BRIEF DESCRIPTION OF THE DRAWINGS

FIG. 1: Process for producing modified silica carrier. As depicted, modified silica particles are made by mixing natural or synthetic amorphous silica, an organic acid, a quaternary ammonium salt, and a 3-glycidyloxypropyl trimethoxysilane (surface modifier). The modification introduces one or more ether moieties and one or more carboxylate end groups to the surface of the silica.

FIGS. 2A-2B: Hierarchical porosity achieved by modified silica. A comparison of the Scanning Electron Microscopy (SEM) images of the surface of modified silica (FIG. 2A) and commercial amorphous silica control (FIG. 2B) demonstrates micro and macro porosity present in surface-modified silica. Scale bar=100 μm.

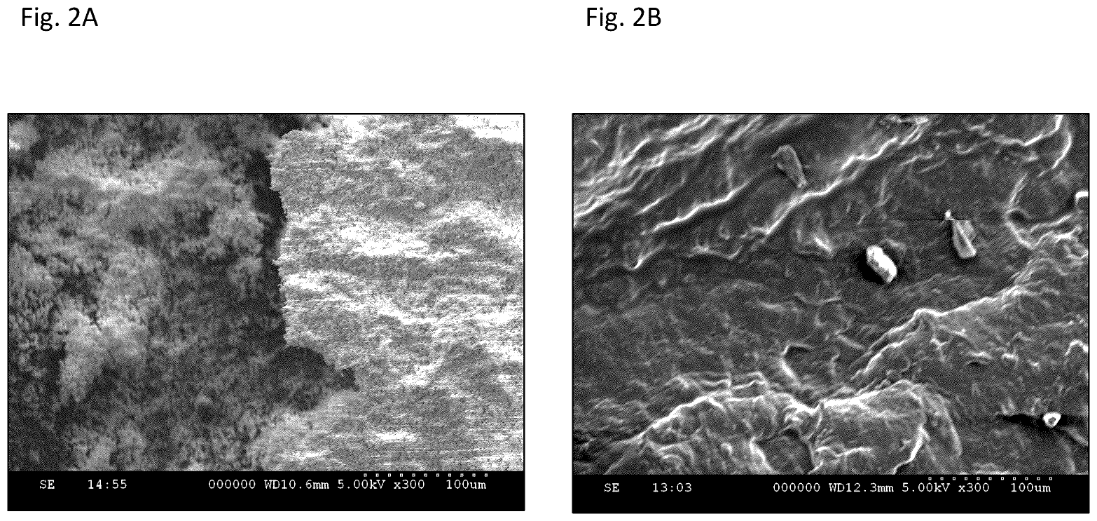

FIG. 3: Adsorption of hydrocarbons in modified silica capsules. SEM image of modified silica containing 65% weight biodiesel, post treated with metal chloride. Scale bar=100 μm.

FIG. 4: Bioremediation system for decontaminating hazardous substances. A self-moderating container is filled with modified amorphous silica (as described in FIG. 1) mixed with biologically active agents comprising bacterial and fungal enzymes and/or Bacillus spp strains. The valve in the container allows the entry of hazardous substances. The color-change window indicates completion of the decontamination process.

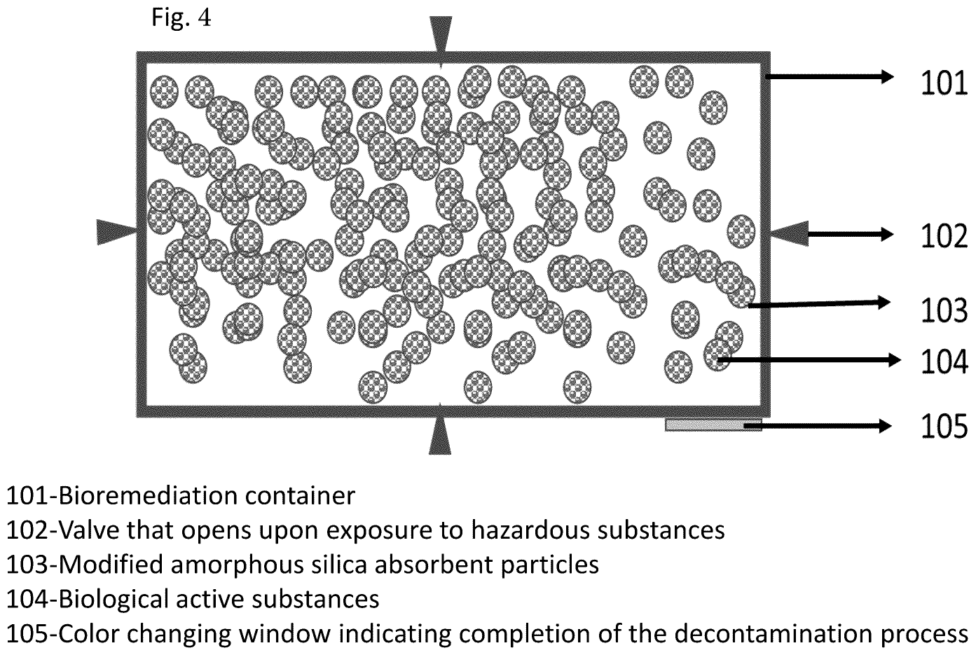

### DETAILED DESCRIPTION OF THE INVENTION

A spill control kit is provided that is helpful for deployment during hazardous chemical spills comprise amorphous silica particles containing microbial enzymes capable of absorbing polar and nonpolar substances and decontaminating the absorbed polar and nonpolar substances within the silica particles.

In one embodiment, the bioremediation kit is packed with citric acid-modified silica (CitraSil) to mitigate current silica-based absorbents' challenges. CitraSil is acid-functionalized amorphous silica and requires no post-gelation step after the microbial addition. CitraSil has a high absorption capacity (Table 1) compared to commercial sol-gel silica due to its hierarchical porosity, meaning it will have nano, micro, and macro-porosity. CitraSil has acid functional surfaces in addition to silanol, holds more than 65 wt % glycerin in their structures due to high hydrogen bonding affinity, and still produces a free-flowing powder. They have high negative zeta potential (preferably-20 mV or more negative at pH=7) and therefore form excellent ionic crosslinks with charged crosslinking agents, a desirable feature for improved microbial stability in the silica capsules. A comparison of the Scanning Electron Microscopy (SEM) images of the surface of CitraSil and commercial control confirms that the micro and macro porosity formation is due to the presence of surface-modified citric acid groups.

To demonstrate the ability of CitraSil to hold hydrocarbon liquid at high concentrations, we mixed in a cement blender 65 wt % of biodiesel to 35 wt % of CitraSil. The resultant product was a free-flowing powder. The powder can be further post-treated with an aqueous Calcium Chloride solution (25 wt %).

The present invention provides a method and system for reducing environmental availability of hazardous contaminants. As used throughout this document, the term “hazardous pollutant” and “hazardous contaminant” means a chemical element or compound or mixture thereof known to be lethal or toxic to humans and/or to impact the environment (ecosystem).

The remediation agents in the practice of this invention comprise modified silica and biological agent, and, preferably, functional silane, quarternary ammonium salt, and/or organic acid. The term “modified” indicates that the silica support has been contacted with a chemical to modify the material. Suitable organic acids that can be used include citric acid, itaconic acid, citraconic acid, lactic acid, glucaric acid and tartaric acid. Suitable biological agents that can be used in the practice of this invention include Bacillus spp, Bacillus subtilis, Bacillus licheniformis, Bacillus pumilus, Bacillus amyloliquefaciens, Bacillus megaterium, Brevibacillus laterosporus, and enzymes derived from bacteria and fungi. Suitable amorphous silica sources for the practice of this invention may be natural or synthetic.

The modified silica and biological substance are mixed prior to application in the environment. Environmental pollutants may be solids, liquids, gases or combinations thereof. Adding a functional silane and organic acid to amorphous silica provides a terminal carboxylate group and ether moiety to stabilize the biological agent to the silica capsules.

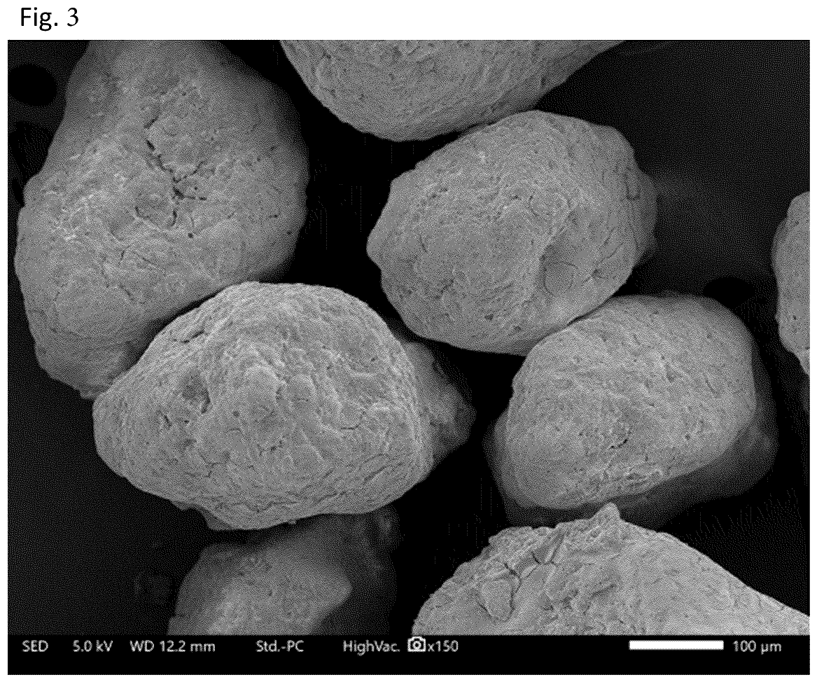

TABLE 1

| | Features | | | | |
|---|---|---|---|---|---|
| | Hierarchal | | | | |
| | porosity to | | | | |
| | hold | | | Absorption | |
| | biomolecules | Zeta | Absorption | capacity to | Ability to |
| | and, in more | potential | capacity to | polar | crosslink |
| | significant | (mV) at | hydrocarbons^{(a)} | liquids ^{(b)} | with |
| Product | concentrations | pH 7 | wt. % | wt. % | CaCl₂ |
| Modified | Yes, see FIG. 3 | −29 | 60-70 | 60-70 | Yes |
| Silica | | | | | |
| Control (sol- | No. Only nanoporous | −18 | Not reported | Not | No |
| gel | | | | reported | |
| synthesized) | | | | | |
| literature | | | | | |
| reported | | | | | |
| values | | | | | |
| Control | No | <−10 | 30-35 | 40-50 | No |
| (Amorphous | | | | | |
| silica, not | | | | | |
| modified) | | | | | |

^{(a)}Methyl soyate was used as hydrocarbon
^{(b)} Glycerol was used as polar liquid

### EXAMPLE 1: PREPARATION OF MODIFIED SILICA

In one embodiment, the method for preparing the modified silica comprises steps (a) to (c):
(a) Mixing 42.79 g of tetramethyl ammonium chloride and 75.01 g citric acid and heated to 120° C. in a oil bath with stirring for 5 h. The reaction mixture is cooled to room temperature to obtain product 1A.
(b) Mixing 80 g amorphous silica (Hi-Sil 213, PPG Industries), 20 g of product 1A and 15.05 g of 3-Glycodyloxypropyl trimethoxysilane and heated to to 80° C. in a oil bath with stirring for 8 h. The reaction mixture is cooled to room temperature to obtain modified silica product 1B.
(c) Adding/mixing the biological agent to the product obtained in step (b) wherein the biological agent comprises microorganisms from the Bacillus genera and/or enzyme derived from bacteria or fungi.
(d) In one embodiment in step (a), mole ratio of quaternary ammonium salt to the organic acid is between 0.5 and 4.
(e) In one embodiment in step (a), preferred temperature is between 40° C. and 180° C.;
(f) In one embodiment in step (a), preferred time for producing the product 1A is between 30 minutes and 18 hours;
(g) In one embodiment in step (b), preferred temperature for making the product 1B is between 20° C. and 120° C.;
(h) In one embodiment in step (a), preferred time for producing the product 1A is between 30 minutes and 18 hours.

### EXAMPLE 2: BIOREMEDIATION SYSTEM AND SET UP

The mixture obtained in Example 1 is used to pack a container (FIG. 5A) designed with at least one valve that opens to allow hazardous contaminants into the container. The container contains at least one window that changes color to indicate the completion of the decontamination process. The valve and the color-change window can be either commercially purchased or developed by the manufacturer.

### EXAMPLES: PREPARATION OF MODIFIED SILICA (CITRASIL)

### Materials

a) Citric Acid
b) Isopropanol
c) Glycidyloxypropyl trimethoxysilane (GPTMS)-Aldrich
d) Hisil 213 (PPG)
e) Water (Tap water unless specified)

### Method

### Step 1: Prepare Citric Acid Solution

In a 2-liter beaker, place a magnetic stir bar and transfer 500 mL of tap water. Place the beaker on a magnetic stir plate. While stirring, add 250 grams of citric acid slowly for over ten minutes. Continue stirring till all the solids are dissolved.

### Step 2: Prepare GPTMS Solution

Place a magnetic stir bar in a 100 ml beaker and transfer 50 grams of isopropanol.
Place the beaker on a magnetic stir plate. While stirring, add 4 grams of GPTMS slowly and continue stirring for 2-3 minutes to ensure complete miscibility of the liquids.

### EXAMPLE 3: PREPARATION OF CITRASIL-1

Amount (grams)

| Ingredients | Calculated | Actual |
|---|---|---|
| Hisil 213 | 100 | 102.4 |
| GPTMS solution (from step | 50 | 54.1 |
| 2) | | |
| Citri acid solution (from | 50 | 50 |
| step 1) | | |

In a laboratory rotating mixer, add Hisil 213 and spin at 60-75 rpm. While rotating, spray the GPTMS solution for 10 minutes, and then spray the Citric acid solution for 20 minutes. Once the spraying is done, transfer the content to a glass tray and place it in a preset oven at 105° C. Allow the product to dry for four hours.

### EXAMPLE 4: PREPARATION OF CITRASIL-2

Amount (grams)

| Ingredients | Calculated | Actual |
|---|---|---|
| Hisil 213 | 100 | 100.1 |
| Citri acid solution (from | 100 | 100 mL |
| step 1) | | |

In a laboratory rotating mixer, add Hisil 213 and spin at 60-75 rpm. While rotating, spray the spray Citric acid solution for 30 minutes. Once the spraying is done, transfer the content to a glass tray and place it in a preset oven at 105° C. Allow the product to dry for four hours.

### EXAMPLE 5 CHARACTERIZATION OF CITRASIL

The product obtained from Example 3 and Example 4 is characterized for their physical properties and reported in the following Table.

### Table: Physical Property Evaluation of CitraSil

| | Product | |
|---|---|---|
| | CitraSil-1 | CitraSil-2 |
| Property | (Example 3) | (Example-4) |
| Volatile matter (%) | 1.2 | 0.7 |
| Density (g/mL) | 0.326 | 0.384 |
| Angle of repose (deg) | 19.2 | 24 |
| pH (1% aqueous solution) | 3-4 | 3-4 |
| HAZMAT Sorption Capacity (volume per | 250-260 | 230-240 |
| 100 g of sample) | | |
| Particle Size (microns) | 478 | 472 |
| Total Porosity (%) | 81 | |
| Total Pore Area (m²/g) | 104 | |

### Details of Analysis

### Volatile Matter (%)

### Procedure:

To determine the VM in a sample, weigh nearly 2 grams of the sample in an Aluminum boat. Following this, place the sample in a preheated oven set at 105° C. for one hour. After the hour, cool in a desiccator for 15 minutes. Once the sample is cooled, weigh it once again. The VM (%) can then be calculated using the formula provided.

$$\\ VM ( \% ) = \frac{w 1 - w 2}{w 1} * 100$$

Where;
w1=Initial weight of the sample
w2=Weight of sample after heat exposure
   Bulk Density (g/mL)

### Procedure:

There must be no agglomeration in the sample to ensure accurate testing results. If any agglomerates have formed during storage, they should be gently broken up to avoid changing the nature of the material. Next, using a dry graduated cylinder readable to 1 mL, introduce 75-100 g of the test sample (M) with 0.1% accuracy. Carefully level the powder without compacting it, and then read the unsettled volume (V) to the nearest graduated unit. Finally, calculate the bulk density in g/mL using the formula M/V.

### Angle of Repose (Fixed Funnel Method)

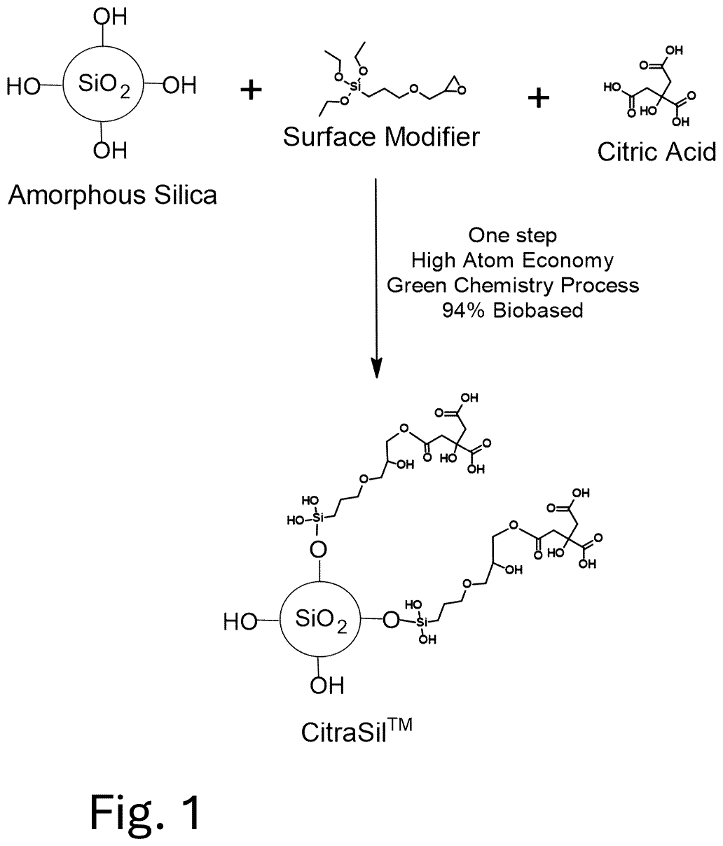

Determining the angle of repose, which assesses the flowability of powder samples, can be done through the fixed funnel method (FFM) or the slowly raising funnel method (SRFM), with experimental apparatus as illustrated in FIG. 1 of: Fang, Yingguang, Xiaolong Li, Lingfeng Guo, Renguo Gu, and Weizhou Luo. 2021. “The Experiment and Analysis of the Repose Angle and the Stress Arch-Caused Stress Dip of the Sandpile.” Granular Matter 24 (1): 7. https://doi.org/10.1007/s10035-021-01171-w. In the FFM, a funnel is positioned on a supporting frame, and the distance between the funnel's outlet and the floor is kept at 53 cm. The powder sample is then released from the funnel's conical outlet, which has a diameter of 22 mm, onto a level laboratory bench. This action results in a powder pile with a height of “h” and a base diameter of “2r.” The angle of repose (AOR) is then calculated using the formula:

$$\\ AOR ( θ ) = {tan}^{- 1} ⌈ \frac{h}{r} ⌉$$

h=Height of the powder pile
r=radius of the powder base

### pH of 1% Aqueous Solution:

Weigh 1 gram of powder with a 0.1% accuracy and then transfer it carefully into a 250 ml beaker. Once the powder is in the beaker, add 100 mL of DI water and stir the contents using a glass rod. Stir for 2-3 minutes to disperse the powder fully. Next, allow the mixture to stand for 10 minutes to allow any sediment to settle. Once the waiting period is over, measure the pH using a pH meter to obtain accurate results.

### HAZMAT Sorption Capacity Vol/100 Gram of Powder)

Carefully weigh 100 grams of the powder sample with 0.5% accuracy and transfer it into a clean 500 ml beaker. Next, while stirring the powder, gradually add the HAZMAT (Xylene/Nonane mixture 1:1 by volume). Observe the physical state of the powder throughout the process to ensure that it's adequately absorbed. Once the liquid seeps out of the powder, note the volume at which this occurs, indicating the saturation point.
Report the Sorption capacity as a range.

### Particle Size Analysis:

The particle size analysis has been conducted on a Malvern® MasterSizer 3000 LASER diffractor. This instrument is considered an ensemble analyzer that calculates a volume distribution from the LASER (Light Amplification by Stimulated Emission of Radiation) diffraction pattern of a suspension of particles. This raw scatter data are then processed using a complex algorithm and presented on the basis of EQUIVALENT SPHERICAL DIAMETER.
Porosity and Pore area: The porosity and pore area has been conducted on a mercury intrusion porosimeter with a working range of approximately 1 psia to 60,000 psia or approximately 0.004 um to 200 um. The instrument measures the volume of mercury, a non-wetting liquid, as it intrudes into a sample at increasing pressures to probe increasingly smaller pores. The Washburn equation was used to calculate the inner EQUIVALENT CYLINDRICAL PORE DIAMETER based on the pressure applied.

### EXAMPLE 6: FORMULATED PRODUCTS FOR THE BIOREMEDIATION OF HAZMAT SPILLS

In a laboratory mixing vessel, first charged the CitraSil sample followed other ingredients in the order it is listed. The contents are mixed at a rate of 300-600 rpm and dried at room temperature for 24 hours.

| | Amount (grams) | | |
|---|---|---|---|
| Ingredients | Control | Example 6a | Example 6b |
| CitraSil-1 (Example 3) | | 25 | |
| CitraSil-2 (Example-4) | | | 25 |
| Bioremediation microbial | 25 | 25 | 25 |
| consortia, supplied by Bio-Cat | | | |
| Microbials | | | |
| Phosphate Buffer/nutrient mix | 6 | 6 | 6 |
| Binder (sodium Silicate) | | 4 | 4 |

Five grams of HAZMAT (Xylene/Nonane1;1 by volume) was added to the above formulated products and tested for microbial stability. In a typical experiment, we weighed two grams of each product and placed it into a sterilized dilution jar containing 198 mL of Butterfield's buffer solution. Afterward, blend the mixture for 2 minutes to ensure proper mixing. We performed a standard 10-fold serial dilution on Trypticase Soy Agar (TSA) using EasySpiral Pro (Interscience, France). Repeated steps 1-3 to produce three replicates of each product to ensure that the results are consistent and that there is minimal room for error.
The results are presented in the following table.

| | |
|---|---|
| Time | Stability (microbial retention) |

| (days) | Control | Example 6a | Example 6b |
|---|---|---|---|
| 0 | 100% | 100% | 100% |
| 7 | 84% | 94% | 100% |
| 14 | 62% | 80% | 100% |
| 21 | 14% | 81% | 100% |
| 28 | Not | 84% | 97% |
| | determined | | |
| 35 | Not | 72% | 84% |
| | determined | | |

It is evident that inventive examples retained more microbes in the presence of hydrocarbons than the control samples.

1. A bioremediation system medium comprising a porous silica support; a siloxy-containing moiety bound to the porous silica support through oxygen bonds to form a modified support comprising a surface moiety comprising an ether moiety and a carboxylate end group; and a biologically active agent coupled to the surface moiety.

2. The bioremediation system medium of claim 1 having 0.5 to 5.0% or 0.7 to 1.5% volatile matter.

3. The bioremediation system medium of claim 1 having a density of between 0.25 and 0.50 or between 0.30 and 0.40 g/mL.

4. The bioremediation system medium of claim 1 having an angle of repose between 15 and 30 or 17 to 25 degrees.

5. The bioremediation system medium of claim 1 having a pH of between 2.5 and 5.0 or between 3.0 and 4.0 when dispersed at 1 mass % in an aqueous solution.

6. The bioremediation system medium of claim 1 having a HAZMAT sorption capacity of between 200 and 300 or between 220 and 270 volume per 100 g of sample.

7. The bioremediation system medium of claim 1 having a particle size of between 200 and 700 or between 350 and 550 or between 400 and 500 μm.

8. The bioremediation system medium of claim 1 having a total porosity of between 70 and 90% or between 75 and 85%.

9. The bioremediation system medium of claim 1 having a total pore area of between 80 and 130 m²/g or between 90 and 120 m²/g or between 100 and 110 m²/g.

10. The bioremediation system medium of claim 1 wherein the biologically active agent comprises Bacillus spp, Bacillus subtilis, Bacillus licheniformis, Bacillus pumilus, Bacillus amyloliquefaciens, Bacillus megaterium, and Brevibacillus laterosporus.

11. The bioremediation system medium of claim 1 wherein the biologically active agent comprises enzymes derived from bacteria and fungi.

12. The bioremediation system medium of claim 1 wherein the surface moiety has a chain length between the siloxy moiety and the carboxylate of between 3 and 15 or between 3 and 10 or between 3 and 7 or between 4 and 8.

13. (canceled)

14. The bioremediation system medium of claim 1 wherein the modified silica particles are made by mixing amorphous silica, an organic acid, a quaternary ammonium salt, and a functional silane and heating the mixture above 80° C. and below 180° C. preferably for at least one hour and not exceeding six hours.

15. A bioremediation system, comprising:
media comprising a biologically-active agent coupled to a silica support;
wherein the media is disposed in a housing;
a valve that selectively permits one or more hazardous materials to enter the housing; and
an indicator that indicates the progress of a decontamination process.

16. The bioremediation system of claim 15 comprising a siloxy-containing moiety bound to a porous silica support through oxygen bonds to form a modified support comprising a surface moiety comprising an ether moiety and a carboxylate end group; and a biologically active agent coupled to the surface moiety.

17. The bioremediation system of claim 15 wherein the housing comprises at least one valve that opens when it encounters hazardous substances and allows the hazardous substances to enter the housing.

18. The bioremediation system of claim 15 wherein the media absorbs at least three percent of its weight of the hazardous substances that enter the container.

19. The bioremediation system of claim 15 wherein the bioremediation system contains at least one window that changes color after decontamination and visually indicates the completion of the decontamination process.

20. The bioremediation system of claim 15 wherein the hazardous substances are polar or non-polar chemicals, biological hazardous waste, or radioactive hazardous waste.

21. A method of remediating a spill of chemical compounds, comprising contacting the chemical compounds with the bioremediation system of claim 15.

22-32. (canceled)
